(19) United States
(12) Patent Application Publication
(10) Pub. No.: US 2026/0104133 A1
(43) Pub. Date: Apr. 16, 2026

(54) Step Support for Retractable Stairs

(71) Applicant: Stouffer Technologies, Inc., Granger, IN (US)

(72) Inventor: John D. Stouffer, Granger, IN (US)

(21) Appl. No.: 18/916,659

(22) Filed: Oct. 15, 2024

(51) Int. Cl. F16M 11/22; B60R 3/02

(52) U.S. Cl. CPC F16M 11/22; B60R 3/02; F16M 2200/08

(57) ABSTRACT

The step supports brace and stabilize retractable stairs used in recreational vehicles, while accommodating uneven ground beneath other recreational vehicles doorways and the various heights of the bottom stair step above the ground. The step supports are configured to be used in one of two different upright orientations resting atop the ground on one to two base ends of the support. The step supports include a plurality of integral support blocks defined and separated by two sets of vertical channels that receive the bottom stair step for each orientation. In each orientation, the bottom stair step is seated within one of the vertical channels and is braced between two adjacent support blocks. The dimensions of the step support end walls and the uniformly spaced support block allow the step supports to be selectively oriented and positioned to brace and stabilize the stairs at incremental heights above the ground.

This invention relates to a step supports for bracing and stabilizing retractable folding steps in recreational vehicles.

### BACKGROUND AND SUMMARY OF THE INVENTION

Recreational vehicles, including motor homes and travel trailers, have raised floors spaced at a considerable elevation above the ground surface which makes it inconvenient and sometimes hazardous for ingress and egress from the recreational vehicles. Recreational vehicles often include retractable stairs to assist in ingress and egress into the elevated vehicle floors. These stairs move from a retracted or stowed position to an extended position from the vehicle toward the ground. The stairs are hinged or otherwise connected at the doorway to extend out and down for use and retract back into or under the vehicle. These retractable stairs include one or more steps connected by parallelogram linkages that maintain a parallel relationship between the vehicle floor and the steps. While the linkages allow the stairs to move from a retracted or stowed position and an extended or use position, the linkages flex and allow the steps to sway and bounce, making the stairs unstable when extended.

The step supports of this invention are configured to brace and stabilize retractable stairs used in recreational vehicles, such as motor homes, fifth wheels, and campers, while accommodating uneven ground beneath recreational vehicles'doorway and the various heights of the bottom stair step above the ground. The step supports act as chocks resting on the ground and are positioned to engage the bottom step of the extended vehicle stairs. The step supports are configured to be used in one of two different upright orientations resting atop the ground on one to two base ends of the support. Each step support includes a plurality of integral support blocks defined and separated by two sets of vertical channels that receive the bottom stair step for each orientation. In each orientation, the bottom stair step is seated within one of the vertical channels and is braced between two adjacent support blocks. The dimensions of the step support end walls and the uniformly spaced support block allow the step supports to be selectively oriented and positioned to brace and stabilized the stairs at incremental heights above the ground.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an exemplary embodiment of the step support of this invention shown in a first orientation;

FIG. 2 is a perspective view of the step support of FIG. 1 shown in a second orientation;

FIG. 3 is a partial perspective view of two of the step supports of FIG. 1 supporting a retractable stair in an extended position;

FIG. 4 is a perspective view of the retractable stair in the stowed position of a recreational vehicle with a portion cutaway to show two of the step supports of FIG. 1 stowed therein;

FIG. 5 is a perspective view of two of the step supports of FIG. 1 joined together;

FIG. 6 is a side view of the step support of FIG. 1;

FIG. 7 is a close up side view from FIG. 6;

FIG. 8 is a sectional view taken along line 8-8 of FIG. 6;

FIG. 9 is a close up sectional view taken from FIG. 8; and

FIG. 10 is another close up sectional view taken from FIG. 8.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

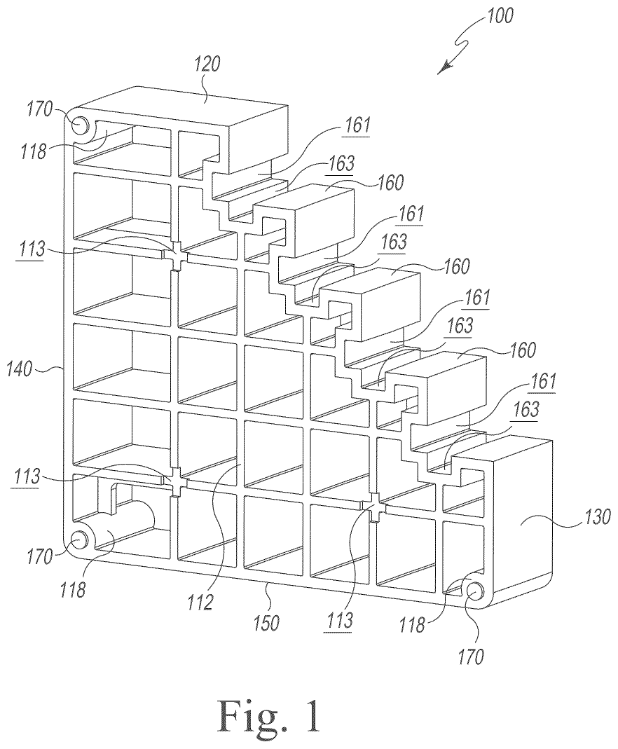

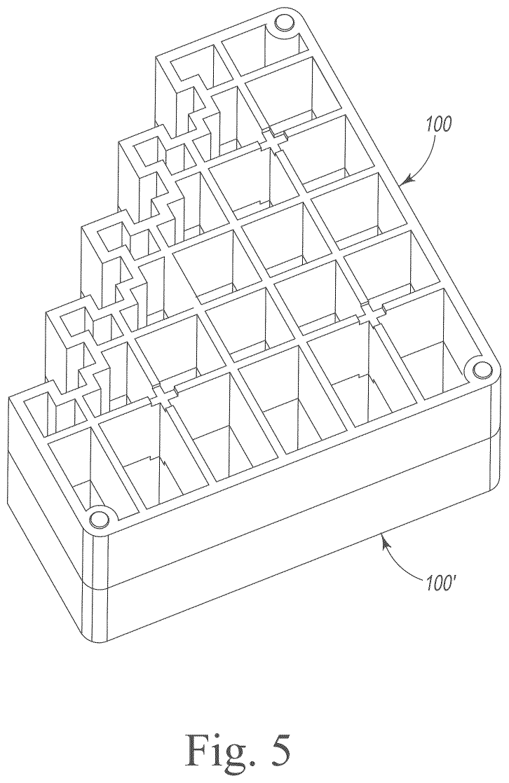

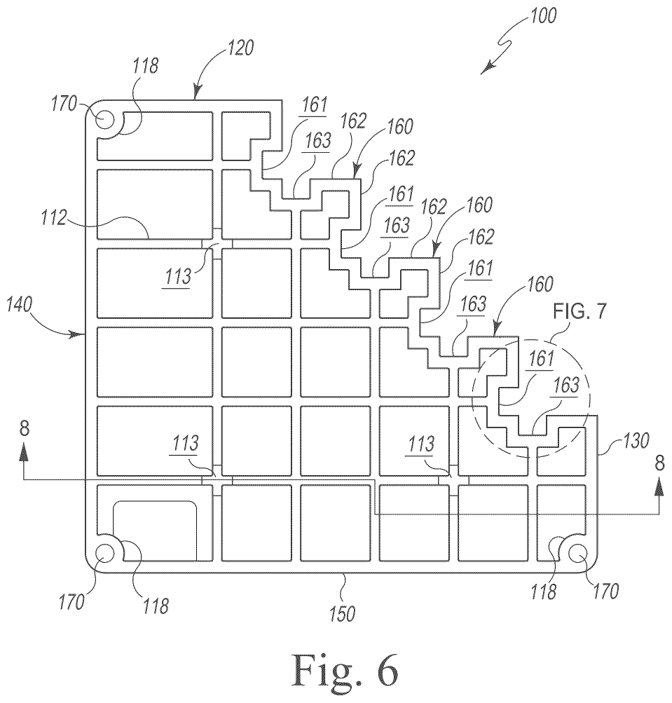

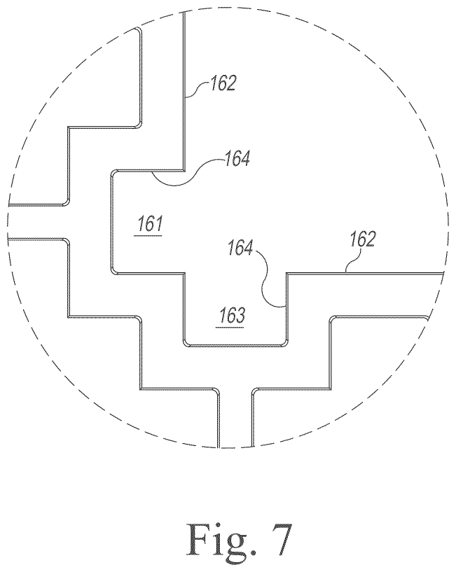

FIGS. 1-10 illustrate an exemplary embodiment of the step support of this invention, which is designated generally as reference numeral 100. The step supports of this invention are configured to brace and stabilize retractable stairs used in recreational vehicles, such as motor homes and campers, while accommodating uneven ground beneath other recreational vehicles'doorways and the various heights of the bottom stair step above the ground. Ideally, the step supports 100 are used in pairs, but one or more support can be used as desired. The step supports are used as “chocks” manually placed on the ground and positioned to engage the bottom step of the extended vehicle stairs. Step supports 100 are configured to be used in one of two different upright orientations resting atop the ground on one to two base ends of the support. Step supports 100 include a plurality of integral support blocks defined and separated by two sets of vertical channels that receive the bottom stair step for each orientation. In each orientation, the bottom stair step is seated within one of the vertical channels and is braced between two adjacent support blocks. The dimensions of the step support end walls and the uniformly spaced support block allow the step supports to be selectively oriented and positioned to brace and stabilized the stairs at incremental heights above the ground.

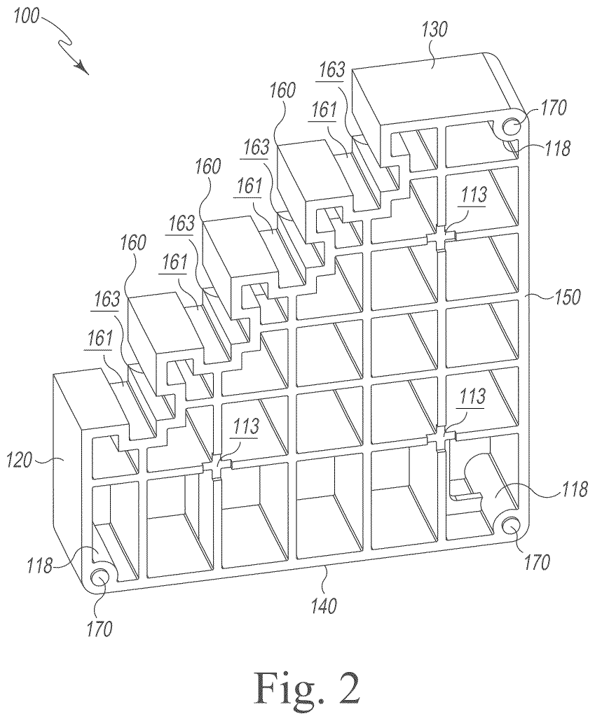

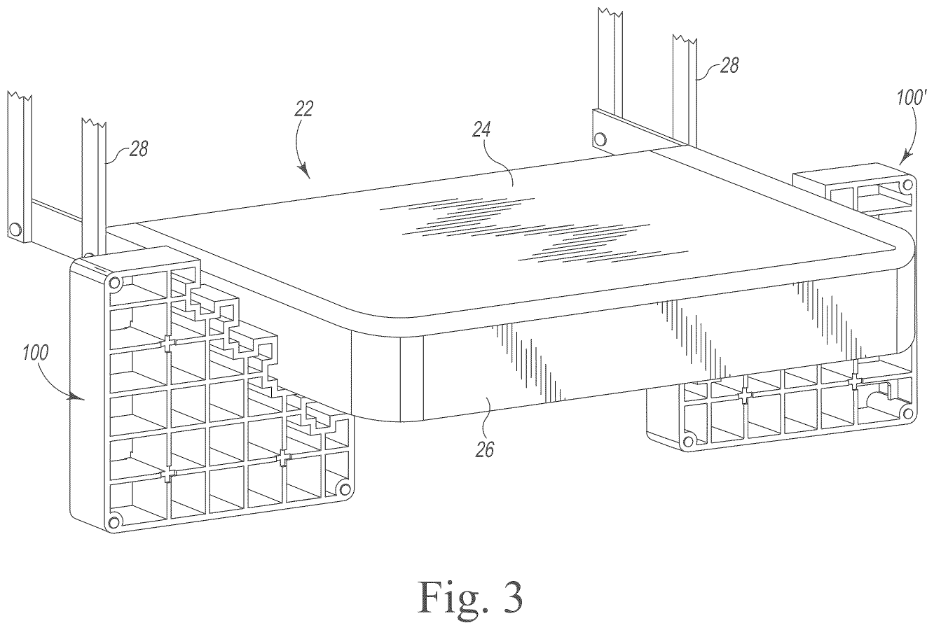

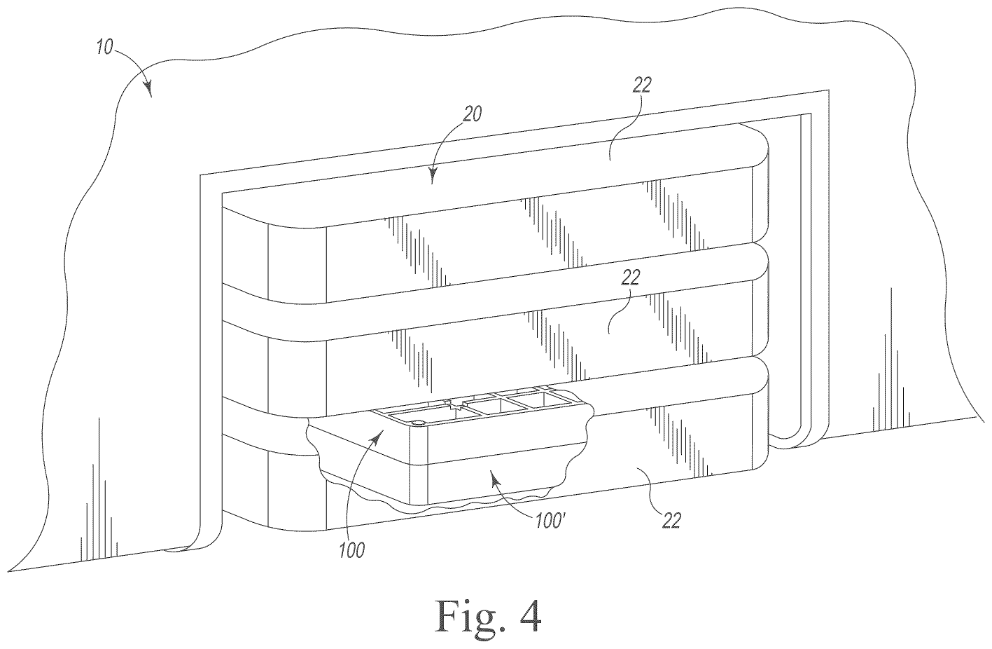

For simplicity of illustration and explanation, step supports 100 are illustrated in use with an exemplary three step retractable stair 20 of a conventional recreational vehicle 10 (partial shown). As shown in FIGS. 2 and 3, stair 20 includes three parallel stair steps 22 interconnected by a set of paired linkages 28. Stair 20 is generally constructed from stamped, formed or machined metal sheets and plates and connected by rivets, pins and fasteners. Each stair step includes a planar horizontal landing 24 and a down-turned, peripheral flange or skirt 26. FIG. 3 illustrates the retractable steps 22 in an extended position descending downward from the recreational vehicle toward the ground. FIG. 4 illustrates the retractable steps 22 stacked atop one another in a retracted position stowed within the recreational vehicle. Although step supports 100 are illustrated in use with retractable stairs 20, step supports 100 can be readily modified and adapted for use with other retractable stair systems for recreational vehicles as well as other non-recreational vehicle related applications.

Each step support 100 is generally a singular component formed or molded from suitable polymer materials, although in other embodiments the supports may be molded or machined from suitable, light weight materials, such as aluminum. Step supports 100 may be dimensioned in any size, but are generally have a 6″×6″ inches square profile. Step support 100 has opposed parallel planar sides and an internal lattice support structure 112. Step supports 100 have four flat end walls including two short end walls 120 and 130 and two long adjacent base end walls 140 and 150. End wall 120 is longer in length than end wall 130. Ideally, end wall 120 has a length one half inch longer than end wall 130. Base end walls 140 and 150 are of equal length and normal to, i.e., perpendicular to one another. Similarly, end wall 120 is generally normal (perpendicular) to base end wall 140 and end wall 130 is generally normal (perpendicular) to base end wall 150.

Step supports 100 also include a set of integral support blocks 160 (three as shown) spaced apart from one another and arranged in the form of inclined “steps” spaced diagonally between end walls 120 and 130 and spaced from first base end walls 140 and 150. Each support block or step 160 has a generally square profile defined and spaced apart by two staggered sets of lateral cross channels 161 and 163. Each set of channels 161 and 163 extend laterally across the width of step support 100 and are oriented normal or perpendicular to the other set of channels. Each set of channels 161 and 163 are dimensionally identical and generally 0.25 inches deep and 0.35 inches wide. Each support block 160 includes two adjacent block walls 162 and two short opposed walls 164. Block walls 162 are ideally 0.65″ in length. Block walls 164 are ideally 0.25 inches in length.

In use, step support 100 is manually positioned under the bottom step of stair 20 between the ground and the step support to act as a “chock” bracing and stabilizing the extended stairs 20. Step support 100 can be employed in one or two different orientations 28 to selectively brace and stabilize stairs 20 at various incremental heights above the ground. 29 In one orientation (FIG. 1), step support 100 rests atop the ground on base end wall 150 30 and channels 163 are oriented vertically to receive step flange 26. In the other orientation (FIG. 2), step support 100 rests atop the ground on base end wall 140 and channels 161 are oriented vertically to receive step flange 26. Step supports 100 are manually positioned and oriented so that step flange 26 seats within one of either sets of channels 161 and 163 and are interposed between adjacent support blocks 160. The dimensions of end walls 120 and 130 and the uniform spacing between support blocks 160 allow a user to adjust the height at which step support 100 supports stairs 20 in increments (half inch) using the support in one of either orientation. In both orientations, vertical channels 161 and 163 are spaced one inch apart to receive step flange 26, but end wall 120 is one half inch longer than end wall 130 so that step support 100 can be selectively oriented and positioned to brace and stabilize stairs 20 in half inch increments regardless of the height of the bottom step 22 above the ground or the whether the ground is level under the stairs.

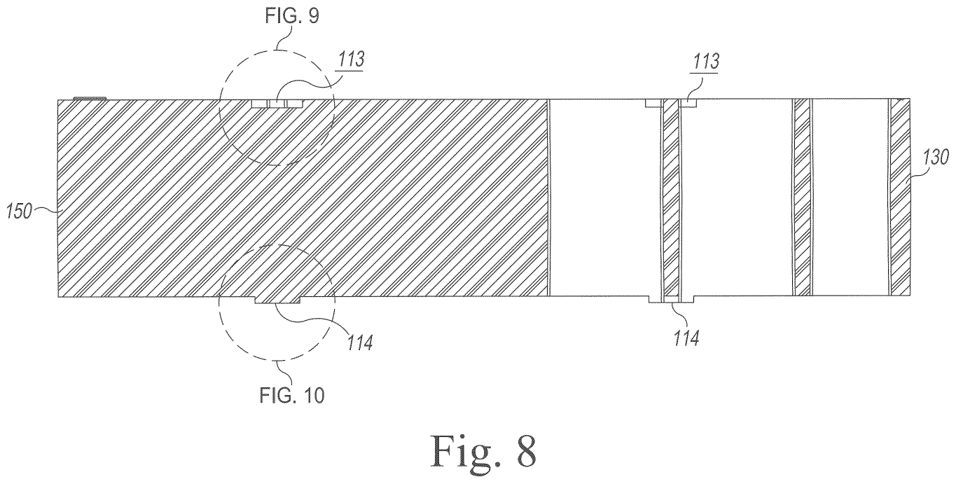

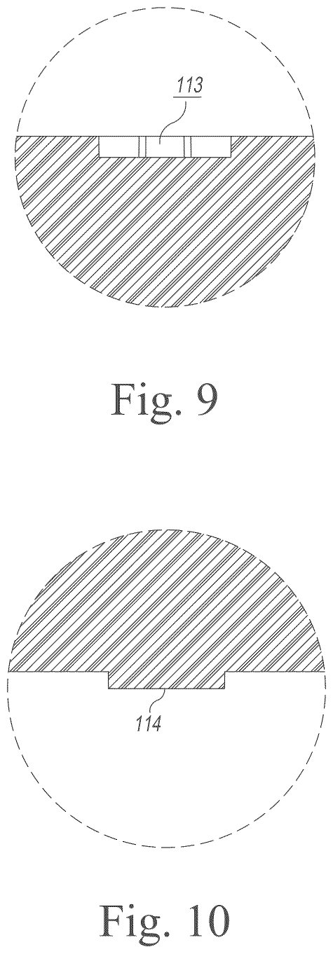

One side of step support 100 has three recessed crosses 113 formed in lattice structure 112 (FIGS. 8 and 9). The other side of step support 100 has three raised cross members 114 extending from lattice structure 112 (FIGS. 8 and 10). Raised cross members 114 of the step supports 100 are located and dimensioned to seat within recessed crosses 113 of another step support to join two or more step supports together for storage when not in use (FIG. 4).

In addition, step supports 100 have three integral bosses 118 at the three corners of end walls 120, 130 and base end walls 140 and 150. Magnets 170 are affixed into axial bores formed in bosses 118. Magnets 170 allow step supports 100 to be detachably mounted to any metallic surface to stowage. As shown, magnets 170 allow step supports 100 to be stacked and detachably connected to the bottom of stair landings 24 for convenient storage and transportation within stairs (FIG. 4).

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A step support for bracing and stabilizing a folding stair in a recreational vehicle relative to the ground, where the stair includes a planar step and a peripheral step flange, the step support comprising:
a first base end wall;
a second base end wall oriented adjacent to the first base end wall; and
a plurality of support blocks spaced apart from one another between the first base end wall and the second base end wall, the plurality of support blocks adapted to restrictively receive the peripheral step flange between adjacent support blocks of the plurality of support blocks,
each of the plurality of support blocks are spaced and separated from one another by a first set of channels where each of the first set of channels is adapted to receive the peripheral step flange of the folding stair therein when the support body engages the folding step with the first base end wall resting against the ground, and a second set of channels where each of the second set of channels is adapted to receive the peripheral step flange of the folding stair when the support body engages the folding step with the second base end wall resting against the ground.

2. The step support of claim 1 wherein the first base end wall is perpendicular to the second end wall.

3. The step support of claim 2 wherein the plurality of support blocks are staggered diagonally between the first base end wall and the second base end wall.

4. The step support of claim 2 wherein each of the support blocks includes a first block wall, a second block wall adjacent to the first block wall, a third block wall opposite the first wall, and a fourth block wall opposite the second wall.

5. The step support of claim 4 wherein the first block wall of one support block and the third block wall of an adjacent support block of the plurality of support blocks engages the peripheral step flange when the peripheral step flange is seated within one of the first set of channels,
the second block wall of one support block and the fourth block wall of an adjacent support block of the plurality of support blocks engages the peripheral step flange when the peripheral step flange is seated within one of the second set of channels.

6. The step support of claim 1 and a first end wall adjacent the first base end wall, and a second end wall adjacent the second base end wall.

7. The step support of claim 7 wherein the first wall has a first length, the second end wall has a second length greater than the first end wall.

8. The step support of claim 1 wherein the support body includes a magnet for stowing the step support against the folding stair.
